(19) United States
(12) Patent Application Publication
(10) Pub. No.: US 2010/0141191 A1
(43) Pub. Date: Jun. 10, 2010

(54) SYSTEMS AND METHODS FOR DETERMINING A COMMUTATION STATE FOR A BRUSHLESS DC MOTOR

(76) Inventors: LIYONG CHEN, Plano, TX (US); Robert Edward Whyte, JR., Dallas, TX (US)

Correspondence Address: TEXAS INSTRUMENTS INCORPORATED, P O BOX 655474, M/S 3999, DALLAS, TX, 75265, US

(21) Appl. No.: 12/328,154

(22) Filed: Dec. 4, 2008

(51) Int. Cl. H02P 6/18

(52) U.S. Cl. 318/400.33

(57) ABSTRACT

A system for determining a commutation state for a brushless DC motor includes flyback detection circuitry that detects a flyback condition for each of a plurality of motor commutation states for the multiphase motor. The flyback detection circuitry provides a detection signal indicative of the detected flyback condition for each of a plurality of motor commutation states for the substantially stationary multiphase motor. A timer provides a time value based on the detection signal, the time value indicating a duration for the flyback condition for each respective motor commutation state. Logic is determines the commutation state for the multiphase motor based on the time value for each of the plurality of motor commutation states.

### TECHNICAL FIELD

The invention relates generally to motor control systems, and more particularly to systems and methods for determining a commutation state for DC motors.

### BACKGROUND

In brushless DC motors it is necessary to determine the rotor position prior to starting the motor. To determine the rotor position, commutation states are defined for the mechanical alignments of the phase windings and magnets. Once the rotor position is known, the correct commutation state can be employed to start the motor.

Determining the correct commutation state is especially difficult when the motor is at rest, because there is no motion induced back electromotive force (“BEMF”) to indicate the present commutation state. If the motor is started in a random commutation state, the motor may start in the reverse direction, and many motors, such as a spindle motor on a hard disk drive, can be impaired or damaged if started in the reverse direction.

Many detection systems exist that determine the position of the rotor in a brushless DC motor. For example, Hall effect sensing circuitry can be fixed to the motor to provide information about the present position of the rotor. The information provided by Hall effect sensing circuitry makes it possible to start the motor in the correct direction. Other motor designs may utilize a rotary encoder to directly measure the rotor's position. Once there is sufficient motion induced BEMF, the BEMF in the undriven windings can be measured to infer the rotor position. Thus, BEMF is useful to control the motor commutation after the motor has reached a sufficient RPM.

### SUMMARY

One embodiment of the invention relates to a system for determining a commutation state for a brushless DC motor. The flyback detection circuitry detects a flyback condition for each of a plurality of motor commutation states for the multiphase motor. The flyback detection circuitry provides a detection signal indicative of the detected flyback condition for each of a plurality of motor commutation states for the substantially stationary multiphase motor. A timer provides a time value based on the detection signal. The time value indicates the duration for the flyback condition for each respective motor commutation state. Logic determines the commutation state for the multiphase motor based on the time values from different motor commutation states.

Another embodiment of the invention relates to a system for determining a commutation state for a brushless DC motor. Pulse control provides a timing signal. A controller controls energization of each phase of the multiphase motor according to the motor commutation state for the multiphase motor, the duration of the energization for each motor commutation state being controlled during a testing mode depending on the timing signal. A timer measures a time interval for a flyback condition for each of a plurality of motor commutation states for the multiphase motor, the time interval indicating a duration for the flyback condition for each respective motor commutation state. Logic determines the commutation state for the multiphase motor based on the time interval measured for each of the plurality of motor commutation states.

Still another embodiment of the invention relates to a method to determine a starting commutation state for a brushless DC multiphase motor. The method includes applying voltage to energize at least a given phase of the multiphase motor during a testing mode while the multiphase motor remains substantially stationary, the given phase being chosen according to a selected commutation state of a plurality of motor commutation states for the multiphase motor. The method also includes terminating the application of voltage to the given phase to establish a flyback condition for the selected commutation state. The method also includes measuring a time interval for a flyback condition for the given phase during a respective one of a plurality of motor commutation states for the multiphase motor, the time interval indicating a duration for the flyback condition for a low-side phase for the selected commutation state. The application of voltage, the termination of the application of such voltage and the measuring can be repeated for each of the other commutation states. The method also includes determining the starting commutation state for the multiphase motor based on which of the plurality of motor commutation states has a shortest time interval.

### BRIEF DESCRIPTION OF THE DRAWINGS

FIG. 1 illustrates a schematic block diagram of a motor system in accordance with an aspect of the invention.

FIG. 2 illustrates an example of a motor position detection system that can be implemented in accordance with an aspect of the invention.

FIG. 3 illustrates an example of a motor position detection system that can be implemented in accordance with an aspect of the invention.

FIG. 4 illustrates a graph of phase voltage and motor winding current versus time in accordance with an aspect of the invention.

FIG. 5 is a table demonstrating the relationship of voltage to be applied to a phase and the phase to measure the flyback voltage versus the commutation states in accordance with an aspect of the invention.

FIG. 6 illustrates a graph of flyback time for each of the commutation state versus the rotor position for a motor implemented in accordance with an aspect of the invention.

FIG. 7 is a flow diagram of a methodology for commutating a motor in accordance with an aspect of the invention.

### DETAILED DESCRIPTION

The invention relates to systems and methods for determining a commutation state for a brushless DC motor.

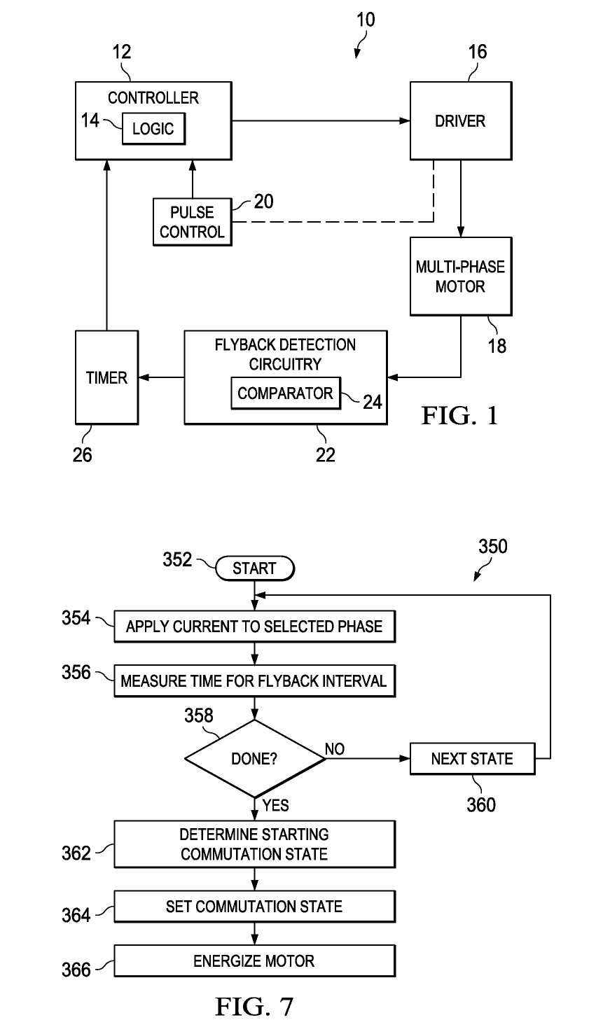

FIG. 1 illustrates a schematic block diagram of a motor system 10 in accordance with an aspect of the invention. The system 10 is configured to determine an appropriate starting commutation state of a multiphase brushless DC motor 18, while the multiphase motor 18 is stationary (e.g., at a dead stop) or nearly stationary. The multiphase motor 18 may have any number of a plurality of phases. The system 10 includes a controller 12 that is configured to control energization of the motor phases by controlling voltage that is applied to one or more of the phases. The controller 12 includes a logic 14 that is configured to provide a control signal for controlling voltage applied to at least two phases of the multiphase motor 18 according to a selected commutation state of the plurality of motor commutation states. The logic 14 controls sequencing of the plurality of motor commutation states during a testing mode that occurs while the multiphase motor 18 is substantially stationary. For instance, a driver 16 is configured to drive at least two of the plurality of phases of the multiphase motor 18 based on a control signal from the controller 12.

A pulse control 20 can be configured to control a duration of a drive pulse applied by the controller 12 during the testing mode. The pulse control 20 controls the drive pulse to be of sufficiently short duration such that substantially no torque is produced by the multiphase motor 18 during the testing mode. Stated differently, the controller 12 provides the drive pulse in response to a timing signal provided by the pulse control 20 during the testing mode. As a result, the controller causes voltage to be applied to at least two phases of the multiphase motor 18 while maintaining the multiphase motor 18 substantially stationary.

As one example, the pulse control 20 may include a pulse generator that provides the timing signal as a pulse having a substantially fixed duration for a given motor commutation state of the multiphase motor 18. The duration of the pulse can be programmable. Once the timing signal has ended for the given commutation state, logic 14 resets the controller 12 for a next commutation state of the multiphase motor 18. The pulse control 20 thus can provide the timing signal to the controller for triggering the end of the drive pulse for the current commutation state.

As another example, the pulse control 20 controls the duration of the timing signal based on current in the motor phases. For instance the pulse control 20 can include a sensor and a comparator. The sensor senses motor current and provides a signal indicative of the sensed current for the motor 18. The comparator provides a comparator output signal that varies based on the sensed phase current relative to a target value. The target value can be programmable to ensure that the current is small enough so that the motor does not produce torque during the testing mode. The comparator outputs a comparator signal for identifying an end of the drive pulse for the given motor commutation state in response to detecting that the motor current reaches the target current value. Once the drive pulse has ended for the given commutation state, the logic 14 resets the controller 12 for energizing a next commutation state.

Flyback circuitry 22 provides a flyback signal indicative of a detected flyback condition for each of the plurality of motor commutation states. The flyback detection circuitry 22 can include a comparator system 24 that is configured to compare a flyback voltage for a selected phase of the multiphase motor 18, corresponding to a given commutation state, relative to a predetermined threshold. The change in the flyback voltage corresponds to the dissipation of stored energy in the phase windings. The comparator system 24 provides a comparator output signal to indicate that the flyback condition for a given commutation state has decayed to below the predetermined threshold. The comparator output signal is used to identify an end of the detected flyback condition for each of the plurality of motor commutation states when energized by the controller 12 during the testing mode for the multiphase motor 18. The flyback detection circuitry detects the flyback condition for the given commutation state after the drive pulse implemented by the controller 12 has ended.

A timer 26 measures the time it takes for the flyback voltage to decay to below the threshold and provides a time value based on the measurement. The time value thus represents a time from deactivation of the given commutation state until the flyback condition for the given commutation state decays to the predetermined threshold. In one embodiment, the predetermined threshold is a programmable voltage value. The predetermined threshold may be set to a fraction below a supply voltage, for example. The timer 26 measures the time value for each of a plurality of possible commutation states (as determined by the logic 14) during the testing mode.

The controller 12 is connected to receive the time value from timer 26. The logic 14 of the controller 12 is configured (e.g., programmed with an algorithm) to determine the appropriate starting commutation state based on the measured time values for the plurality of commutation states.

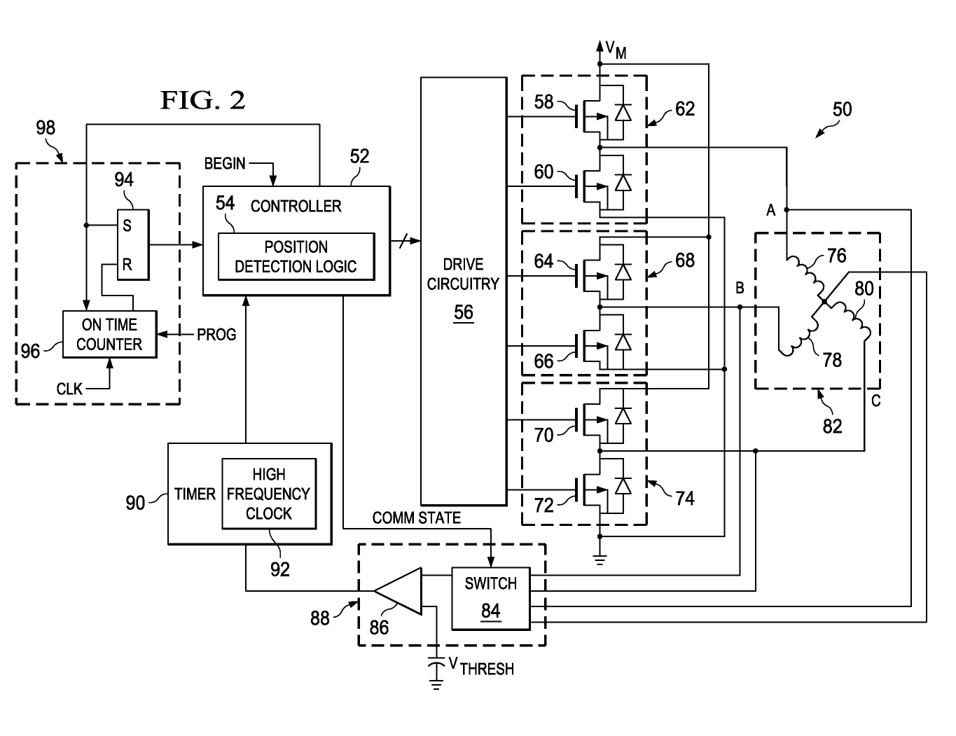

FIG. 2 illustrates an example of a motor system 50 that can be implemented to detect a motor position in accordance with an aspect of the invention. In the illustrated implementation, a three phase Y-configured motor 82 is shown. One skilled in the art will appreciate that the system 50 can function for a motor having any plurality of phases or with other types of motor configurations (e.g., delta or Y-delta configurations).

System 50 includes a controller 52 configured to control the current that is applied to at least two windings of a motor 82. The controller 52 provides control signals to drive circuitry 56 which provides drive signals to half-bridges 62, 68, and 74. Collectively, the half-bridges 62, 68, and 74 form a driver that provides the current to selected phase windings 76, 78, and 80 based on control signals from the controller 52. The half bridges 62, 68, and 74 subsequently control energization of the respective phase windings 76, 78 and 80. During a testing mode, the current applied to the respective phase windings is sufficiently small so that substantially no torque is produced.

In the example of FIG. 2, the half-bridges 62, 68, and 74 are each represented as two Field Effect Transistors (FETs) configured to provide current to a corresponding winding 76, 78, or 80 of the multiphase motor 82 based on a control signal from the controller 52. For example, half-bridge 62 includes a first FET 58 and a second FET 60 connected in series between a control voltage (V_{M}) and ground. An intermediate node between the FETs 58 and 60 is coupled to winding 76. The controller 52 provides control signals to operate at least two of the plurality of windings in a driven state. For instance, if FET 58 is on and FET 60 is off, half-bridge 62 drives the winding 76 to V_{M}. Similarly, half-bridge 68 includes FET 64 and a second FET 66 connected to drive winding 78 and half-bridge 74 includes FET 70 and a second FET 72 coupled to drive winding 80. Each of the phase windings 76, 78 and 80 can be driven to V_{M} or GND depending on the control signal provided for the commutation state of the multiphase motor 82. One skilled in the art will appreciate that components other than FETs can be used to implement a driver (e.g. bipolar junction transistor (BJT), relay, etc.).

The system 50 also includes a pulse control 98 that is configured to control the duration of drive pulse applied to the windings 76, 78, 80 during the test mode. As described herein, the duration of the drive pulse is controlled to be sufficiently small during the testing mode so as not to produce any substantial amount of torque. In the example of FIG. 2, the pulse control 98 includes reset logic 94 and a counter 96 that cooperates to provide an output pulse to the controller 52 having a substantially fixed duration.

For example, the counter 96 provides an output signal to a reset (R) input of the reset logic 94 and the controller 52 provides an output to the set (S) input of the reset logic 94 and to a start input of the counter 96. Thus, the pulsed output from controller 52 (corresponding to application of a control signal to energize windings) triggers the activation of a pulse at the output of reset logic 94 as well as causes the counter 96 to start counting. When the counter 96 reaches a predetermined value, the output of the counter to the reset input of the reset logic 94 is asserted to cause the pulsed output from the reset logic to the controller to change states or to de-assert. This transition in the reset signal can cause the controller 52 to advance to a next commutation state in the commutation sequence during the testing mode. This process can be repeated during the testing mode to provide a substantially fixed drive time for motor windings. It will be appreciated that the duration of the drive pulse can be programmable, such as by programming the maximum count value of the counter 96 with a PROG value.

Flyback detection circuitry 88 is configured to detect the flyback condition for each of a plurality of motor commutation states for the multiphase motor 82. Flyback detection circuitry 88 includes a switch network 84 that is configured to select one of the windings 76, 78, and 80 to an input of a comparator 86 according to a commutation state signal, such as provided by the controller 52. The phase voltage is selected according to the commutation state signal provided by the controller 52 that indicates which phase voltage is being measured by the flyback detection circuitry. For example, the switch network can be controlled to measure the phase winding of the motor connected to GND for a given commutation state in a commutation sequence. The sequence during the test mode can be the same as the commutation sequence for energizing the motor 82 during normal operation or the sequence can be different from the motor commutation sequence. The comparator 86 compares the selected phase voltage relative to a predetermined threshold. The predetermined threshold may be a programmable fixed voltage value that is less than V_{M}, such as ¾V_{M} or another fractional portion of V_{M}. The comparator 86 provides an output signal indicative of the detected flyback condition for each of a plurality of motor commutation states for the substantially stationary multiphase motor 82.

A timer is connected to receive the comparator output signal from the flyback detection circuitry 88. The timer 90 measures a time value indicative of the duration of the flyback condition for a given phase. For instance the timer can provide a time value corresponding to the measured time difference between when the end of the drive pulse and when the flyback voltage crosses the predetermined threshold (e.g., ¾ V_{M}). The timer 90 can be a free running timer in which the measured time value corresponds to a difference between start and stop times. Alternatively, the timer can be reset at the end of the drive pulse to provide a time value that indicates the duration of the flyback condition. Those skilled in the art will understand and appreciate various types of timer circuits that can be utilized, such as including a counter and high speed clock as well as other logic to control resetting the counter.

The controller 52 is connected to receive the timer output indicative of the measured time value. The position detection logic 54 of the controller 52 is configured to determine the appropriate commutation state based on the time values for the plurality of commutation states. The position detection logic 54 may implement an algorithm to determine a starting commutation state for the motor 82. For example, the algorithm can compare the time values for each of the commutation states to identify a starting commutation state based on which of the commutation states has the smallest time value. The position detection logic 54 can provide the starting commutation state information to the controller 52, such that the appropriate starting commutation state can be energized. The controller 52 thus can provide control signals to the appropriate half bridges 62, 68, and 74 to begin to energize the phase windings 76, 78, and 80, and thereby begin motor commutation from the stationary position.

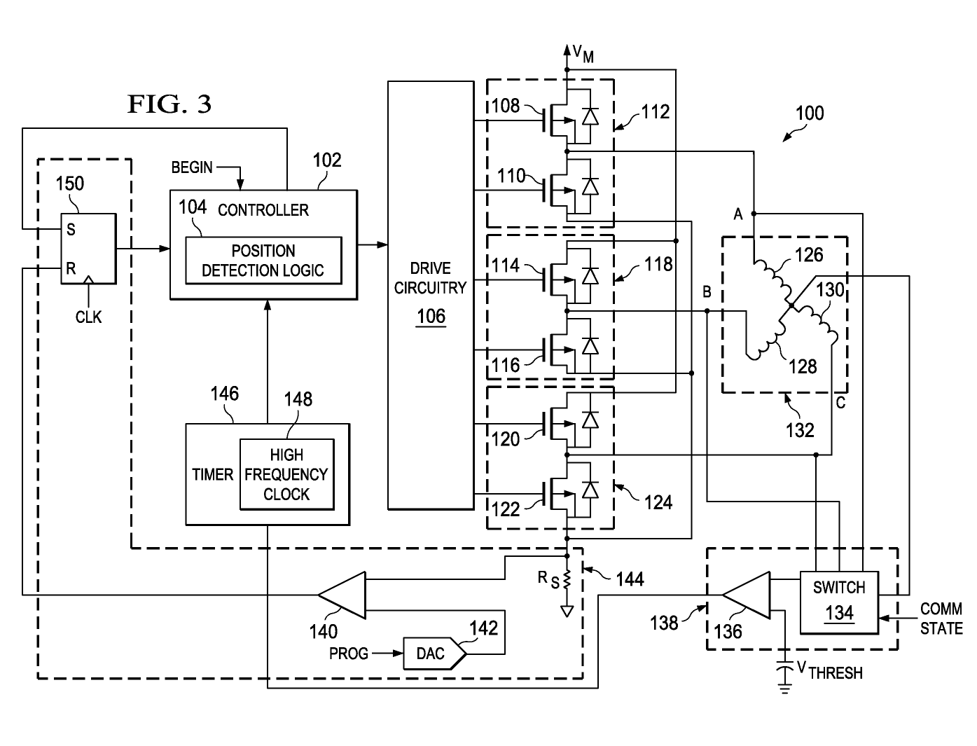

FIG. 3 illustrates an example of a motor system 100 employing another example of a rotor position detection system. In FIG. 3, it will be appreciated that reference numbers 102-138 generally correspond to elements 52-88 of FIG. 2 increased by adding 50. For the sake of brevity, such common features may be described briefly or be omitted altogether in the description of FIG. 3. Additional information about such elements is available by referring back to such corresponding elements in the description of FIG. 2.

The system 100 includes a controller 102 which provides control signals to drive circuitry 106. The drive circuitry 106 in turn applies drive signals to respective half-bridges 112, 118, and 124 to control current that is applied to the respective windings 126, 128, and 130.

The system 100 further includes a pulse control 144 that is configured to control the duration of a drive signals applied to the windings during a test mode. In the example illustrated in FIG. 3, the pulse control 144 is connected with the half-bridges 112, 118, and 124 for measuring drive current through the motor windings during the testing mode. The pulse control 144 includes a comparator 140 having a first input that receives a signal indicative of the drive current. For example, the first input signal is generated by a current sense resistor R_{S} connected between the low side portion of the half-bridges and ground. A second input of the comparator 140 receives a predetermined voltage, such as provided by a Digital to Analog Converter (DAC) 142. The predetermined value is provided by DAC 142 and may be programmable (e.g., based on a PROG signal from a programmable register or other device (not shown)). The comparator provides a corresponding output signal to reset logic 150. The comparator 140 thus provides an output to the reset logic 150 to indicate that the current being applied to the drive the respective winding for a given commutation state of multiphase motor 132 has reached a predetermined current level.

The reset logic 150 (e.g., an SR flip flop) provides a timing signal to the controller 102 based on the output of the comparator 140. For instance, a reset (R) input receives the output signal from the comparator 140 and the controller 102 provides a signal to the set (S) input of the reset logic 150 based on which the reset logic provides the reset signal to the controller for controlling the duration of the drive pulse. The reset logic 150 thus resets the controller 102 to advance to a next commutation state in response to the output of the comparator indicating that the motor current has exceeded the predetermined level.

Flyback detection circuitry 138 is substantially similar to that shown and described with respect to FIG. 2. Briefly stated, flyback detection circuitry 138 is configured to detect the decay of the phase voltage during flyback condition for each of a plurality of motor commutation states for the multiphase motor 132. Flyback detection circuitry 138 includes a switch network 134 that is configured to couple the phase voltage of a selected one of the windings 126, 128, 130 to an input of a comparator 136 according to a commutation state (COMM STATE) signal, such as provided by the controller 102. A comparator 136 compares the selected phase voltage relative to a predetermined threshold, such as ¾V_{M} or another fractional portion of the supply voltage V_{M} that can indicate that flyback current has decayed to nearly zero. The comparator 136 provides an output signal indicative of the end of a detected flyback condition for each of a plurality of motor commutation states.

The comparator 136 of the flyback detection circuitry 138 provides the comparator output signal to the timer 146, which is configured to measure a duration for the flyback current to decay to nearly zero, such as described herein. The timer 146 provides a time value to the controller 102 indicative of the measured duration for the flyback condition.

The controller 102 includes position detection logic 104 configured to determine the appropriate commutation state based on the measured time values for the plurality of commutation states. Time values for one or more of the commutation states can be stored in the controller 102 or other memory (not shown). For example, the resulting time value can be compared with the previously shortest time value and only the shortest time and state information is saved. The commutation state having the shortest time value can identify a best estimate for the starting rotor position. The commutation state to achieve maximum torque can be one or two states advanced from the detected state depending on motor configuration. This state is used by the controller 102 to provide corresponding control signals to the drive circuitry 106 to begin energizing the motor 132 for normal operation.

It will be appreciated by those skilled in the art that, with the approach shown and described herein (e.g., FIGS. 1-3), it is not necessary to wait or delay applying current to a next phase winding in the commutation sequence during testing since the approach employs flyback detection circuitry 138 which indicates the flyback current in the windings has already decayed to substantially zero. That is, after the flyback detection circuitry has detected that the phase voltage has decayed to or below the threshold, the controller 102 can immediately begin energizing the next phase in the commutation sequence. As a result, the approach described herein can determine a starting position in generally less time than many existing methods.

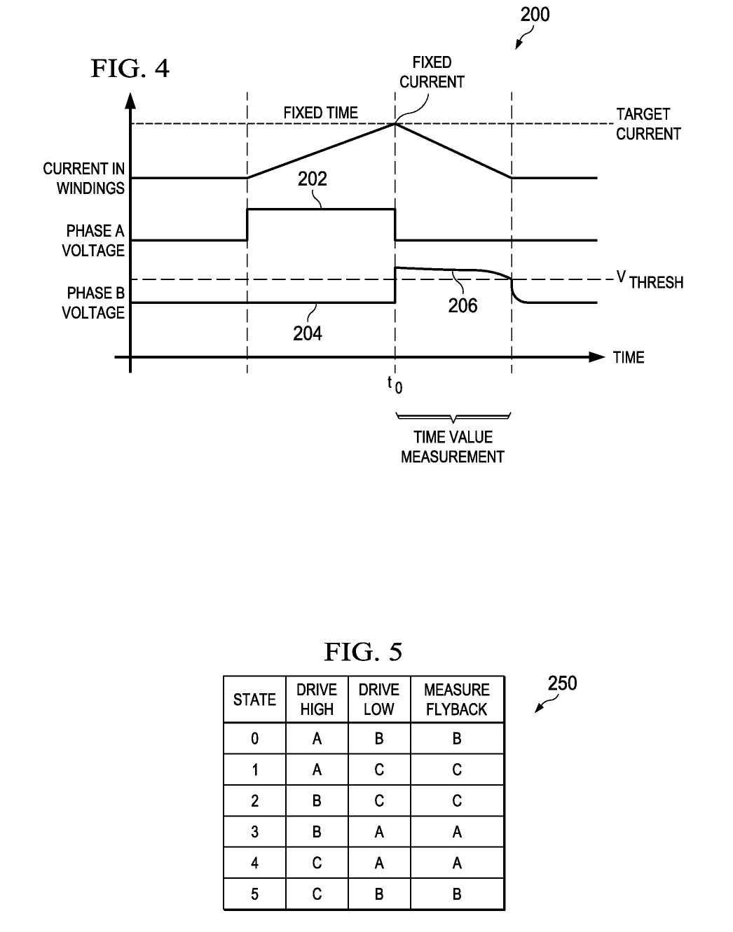

FIG. 4 illustrates a graph 200 of a timing diagram demonstrating the timing relationship between current and phase voltages for a motor being tested in accordance with an aspect of the invention. In the example of FIG. 4, labels PHASE A VOLTAGE and PHASE B VOLTAGE are used to designate the phase voltage corresponding to respective windings A and B of a three phase brushless DC motor. The label CURRENT IN WINDINGS is indicative of the total current being applied to the motor during the sample interval during such testing. As PHASE A is driven to V_{M}, indicated at 202, and PHASE B is driven GND, indicated at 204, the current in the motor windings increases. When the application of voltage to PHASE A and PHASE B is removed at time to, the current in the motor windings causes the voltage of PHASE B to fly to V_{M} immediately, indicated at 206. As the current in the windings decays to zero, the voltage at phase B goes back to GND. A TIME VALUE MEASUREMENT is taken during the flyback condition. The TIME VALUE MEASUREMENT begins, for example, when the application of current is terminated, such as described herein. When the low-side PHASE B VOLTAGE falls below V_{THRESH} the TIME VALUE MEASUREMENT can be stored along with the commutation state information. Thus, the time value for a given commutation state (e.g., commutation state 0 for the example of FIG. 4) corresponds to the time for the phase voltage B 206 to decay below V_{THRESH} during a flyback condition.

Current is applied to the driven phase A based on control signals from a controller to enable such testing without producing any substantial amount of torque by the motor. As described herein, the current can be applied to the motor in different manners. As one example, CURRENT IN WINDINGS drives PHASE A until a fixed period has elapsed, indicated by the label FIXED TIME. As another example, CURRENT IN WINDINGS can be driven through PHASE A until a target current value is reached, indicated by the label TARGET CURRENT.

FIG. 5 illustrates an example of a table 250 of commutation states, corresponding phase voltage to drive, and the phase for which the flyback time is measured. This table can be used by programming logic in determining the rotor position to start a motor. In the example of FIG. 5, labels A, B, and C are used to designate respective phases of a three phase brushless DC motor. In the exemplary implementation of a three phase motor, time value measurements indicative of a flyback condition are taken for each of six commutation states, indicated as states 0, 1, 2, 3, 4, and 5. For example, the commutation state 0 illustrates the use of the table. For this state, phase A is driven to HIGH (V_{M}) as shown in the second column and phase B is driven to LOW (GND) as shown in the third column. The time value is taken from the phase that is driven to LOW (GND), as shown in the fourth column.

As described herein, the time value measurements can be made by a timer (e.g., a counter employing a high frequency clock) configured to measure a duration for the flyback voltage to decay below a threshold voltage from termination of the drive period. Each time value can be made one or more times for each commutation state during the testing mode. One skilled in the art will appreciate that time value measurements may be made in an alternative sequence to that illustrated in FIG. 5.

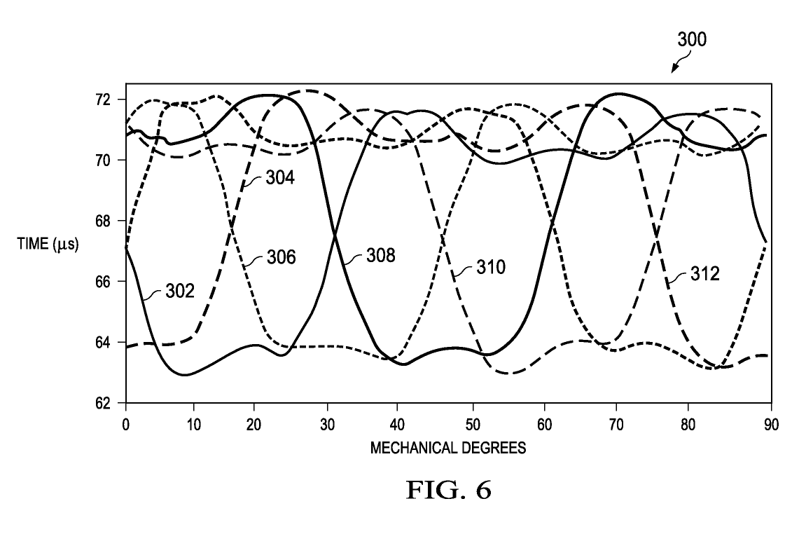

FIG. 6 illustrates a graph 300 of flyback time versus rotor position of an eight-pole, three-phase brushless DC motor. For the example of FIG. 6, flyback time measurements were taken on a motor assembly for the six commutation states as in FIG. 5 at different rotor positions for one electrical cycle, or ninety mechanical degrees. Each curve 302, 304, 306, 308, 310 and 312 represents flyback time measurements for one of the states in FIG. 5. The flyback time measurements are performed after applying voltages to the motor windings for a fixed time period or after the motor current reaches a fixed value. Those skilled in the art will understand that the time value measurements will vary depending on the motor configuration.

To determine the best state to drive the motor in the forward direction with maximum torque at a certain rotor position, values on curves 302, 304, 306, 308, 310 and 312 at that position are compared. The state with the shortest time for the given position indicates the best driven state to get the maximum torque. This is because, for a given rotor position, the magnetic poles of the rotor are aligned with the field applied by the stator windings, which results in a faster decay of winding current or shortest voltage flyback time after the applied power is removed. The state to drive in the normal operation may be one or two states advanced from the detected state depending on the configuration of the motor. Whether to use one or two states advanced from the detected state may be determined by testing.

FIG. 7 illustrates a methodology 350 for determining an appropriate starting commutation state for a motor in accordance with an aspect of the invention. The methodology 350 begins at 352, such as corresponding to a test mode where the motor is at a substantially stationary or dead stop condition (e.g., less than about 1-2% of its rated speed) and the current in the motor windings is zero.

At 354, voltage is applied to the phases of the motor based on a control signal for a fixed period time or until the current through the windings reaches a predetermined threshold current. Then the drive voltage is removed from the motor. At 356, the time value is taken and recorded. The time value for a given commutation state corresponds to an amount of time from removal of the driving voltage from motor phases to the point when the current of motor windings decays to zero, when the voltage at motor phase driven to GND crosses a predetermined threshold. At 358, it is determined whether a time value has been measured for each of the commutation states. If not, the methodology 350 proceeds to 360 in which the commutation state is incremented to a next commutation state (see, e.g., FIG. 5). From 360, the methodology 350 repeats blocks 352, 354, 356, and 358 for the next commutation state until a time value has been measured for each commutation state.

Once it has been determined that the time delay measurements have been made for each commutation state, the method proceeds from 358 to 362. At 362, the starting commutation state is determined based on an evaluation of the time value measurements. It is to be appreciated that the determination of the motor position and starting commutation state can be based on an evaluation of each of the time values and commutation state information that have been stored in memory. Alternatively, the shortest time value, as compared to preceding time value measurements, can be stored in memory at 356 and used in the determination of the starting commutation state at 362. At 364, the determined starting commutation state is set from which a controller can begin commutation of the motor. At 366, the motor is energized according to commutation state set at 364, such as to begin normal operation of the motor.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications and variations that fall within the scope of this application including the appended claims.

What is claimed is:

1. A system for determining a commutation state for a multiphase motor, comprising:
flyback detection circuitry detecting a flyback condition for each of a plurality of motor commutation states for the multiphase motor, the flyback detection circuitry providing a detection signal indicative of the detected flyback condition for each of the plurality of motor commutation states for the multiphase motor while substantially stationary;
a timer providing a time value based on the detection signal, the time value indicating a duration for the flyback condition for each respective motor commutation state; and
logic determining the commutation state for the multiphase motor based on the time value for each of the plurality of motor commutation states.

2. The system of claim 1, wherein the detection signal identifies a termination of the detected flyback condition for each of the plurality of motor commutation states of the multiphase motor during a testing mode.

3. The system of claim 2, the time value representing a time from deactivation of an activated one of the plurality of motor commutation states until the flyback condition for the activated one of the motor commutation states decays to a predetermined level.

4. The system of claim 2, wherein the flyback detection circuitry further comprises a comparator configured to compare a phase voltage for a selected low-side phase of the multiphase motor for a given commutation state relative to a threshold voltage, the comparator providing a comparator signal to indicate that the phase voltage has decayed below the threshold voltage, the timer providing the time value based on the comparator signal.

5. The system of claim 4, wherein the flyback detection circuitry further comprises a switch network configured to connect the phase voltage for the selected low-side phase of the multiphase motor to a first input of the comparator based on a selection signal indicative of the commutation state of the multiphase motor, the threshold voltage being provided to a second input of the comparator.

6. The system of claim 1, further comprising:
pulse control configured to provide a timing signal; and
a motor controller that is configured to control energization of each phase of the multiphase motor according to the motor commutation state for the multiphase motor, the duration of the energization for each motor commutation state depending on the timing signal.

7. The system of claim 6, wherein the pulse control further comprises:
a sensor that senses motor current for a given motor commutation state of the multiphase motor; and
a comparator configured to provide a comparator output signal that varies based on the sensed current relative to a target current value, the comparator output signal identifying an end of energization of a given phase of the multiphase motor for the given motor commutation state.

8. The system of claim 7, further comprising logic configured to reset the timing signal for energizing a next commutation state in response to the comparator output signal for the given motor commutation state.

9. The system of claim 6, wherein the pulse control further comprises:
a pulse generator configured to provide the timing signal as a pulse having a substantially fixed duration for each of the plurality of motor commutation states.

10. The system of claim 9, further comprising a counter configured to provide a reset signal that causes the pulse generator to transition the pulse for indicating to the motor controller an end of energization of a given phase of the multiphase motor for a respective motor commutation state.

11. The system of claim 6, wherein the pulse control is configured to provide the timing signal as a pulse having a duration that is sufficient to cause current to flow through at least two phases of the multiphase motor during a testing mode while maintaining the multiphase motor substantially stationary and producing substantially no torque.

12. The system of claim 1, further comprising:
a controller that is configured to provide a control signal that controls energization of at least two phases of the multiphase motor according to a selected commutation state of the plurality of motor commutation states, the controller controlling sequencing of the plurality of motor commutation states during a testing mode while the multiphase motor remains substantially stationary; and
driver circuitry configured to provide current to the at least two phases of the multiphase motor based on the control signal.

13. A system to determine a commutation state of a brushless DC multiphase motor, comprising:
pulse control providing a timing signal;
a controller controlling energization of each phase of the multiphase motor according to the motor commutation state for the multiphase motor, the duration of the energization for each motor commutation state being controlled during a testing mode depending on the timing signal;
a timer measuring a time interval for a flyback condition for each of a plurality of motor commutation states for the multiphase motor, the time interval indicating a duration for the flyback condition for each respective motor commutation state; and
logic configured to determine the commutation state for the multiphase motor based on the time interval measured for each of the plurality of motor commutation states.

14. The system of claim 13, further comprising flyback detection circuitry configured to detect an end of the flyback condition for each of the plurality of motor commutation states, the flyback detection circuitry providing a detection signal to indicate the end of the flyback condition for a given commutation state of the plurality of motor commutation states, the timer providing a time value in response to the detection signal from the flyback detection circuitry.

15. The system of claim 14, wherein the flyback detection circuitry further comprises:
a comparator configured to compare a phase voltage for a selected low-side phase of the multiphase motor for the given commutation state relative to a threshold voltage, the comparator providing the detection signal to indicate that the phase voltage has decayed below the threshold voltage; and
a switch network configured to provide the phase voltage for the selected low-side phase of the multiphase motor to a first input of the comparator based on a selection signal corresponding to the given commutation state of the multiphase motor, the threshold voltage being provided to a second input of the comparator, the timer providing the time value based on the detection signal.

16. The system of claim 14, wherein the pulse control further comprises:
a sensor that senses motor current for the given commutation state of the multiphase motor; and
a comparator configured to provide a comparator output signal that varies based on the sensed current relative to a target value, the comparator output signal identifying an end of the timing signal for a respective motor commutation state.

17. The system of claim 13, wherein the pulse control further comprises a pulse generator configured to provide the timing signal as a pulse having a substantially fixed duration for each motor commutation state of the multiphase motor.

18. The system of claim 13, wherein the logic is programmed to determine the commutation state for the multiphase motor based on which of the plurality of motor commutation states has a shortest time interval measured by the timer.

19. A method to determine a starting commutation state for a brushless DC multiphase motor, the method comprising:
(i) applying voltage to energize at least a given phase of the multiphase motor during a testing mode while the multiphase motor remains substantially stationary, the given phase being chosen according to a selected commutation state of a plurality of motor commutation states for the multiphase motor;
(ii) terminating the application of voltage to the given phase to establish a flyback condition for the selected commutation state;
(iii) measuring a time interval for a flyback condition for the given phase during a respective one of the plurality of motor commutation states for the multiphase motor, the time interval indicating a duration for the flyback condition for a low-side phase for the selected commutation state;
repeating (i), (ii) and (iii) for each of the other commutation states; and
determining the starting commutation state for the multiphase motor based on which of the plurality of motor commutation states has a shortest time interval.

20. The method of claim 19, further comprising:
comparing a phase voltage for a selected low-side phase of the multiphase motor for the selected commutation state relative to a threshold voltage; and
providing a comparator signal to indicate that the phase voltage has decayed below the threshold voltage, the time interval being measured from termination of the application of current to when the comparator signal has been provided.
